(19) United States
(12) Patent Application Publication
(10) Pub. No.: US 2008/0072047 A1
(43) Pub. Date: Mar. 20, 2008

(54) METHOD AND SYSTEM FOR CAPWAP INTRA-DOMAIN AUTHENTICATION USING 802.11R

(75) Inventors: Behcet Sarikaya, Wylie, TX (US); Robert Jaksa, Irving, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FutureWei Technologies, Inc., Plano, TX (US)

(21) Appl. No.: 11/749,738

(22) Filed: May 16, 2007

Related U.S. Application Data
(60) Provisional application No. 60/846,182, filed on Sep. 20, 2006.

(51) Int. Cl. H04L 9/32; H04K 1/00; H04L 9/16

(52) U.S. Cl. 713/171; 380/247; 380/45

(57) ABSTRACT

An solution for a mobile station to perform intra-domain inter-access controller authentication using an 802.11r protocol in CAPWAP architecture is presented. The access controller is the authenticator that is configured to store a top-level and second-level shared authentication keys in a key hierarchy defined in 802.11r. The mobile station first-time association and re-association after inter-access-point handoff can be performed through authentication request/response message exchange between the mobile station and the access controller. The new access controller after handoff gets top-level key from the old access controller called an anchor authenticator. The mobile station and the new access controller generate a new second-level key and session key to complete the authentication.

### CROSS-REFERENCES TO RELATED APPLICATIONS

This application claims priority to U.S. Provisional Patent Application No. 60/846,182, filed on Sep. 20, 2006, commonly assigned, incorporated by reference herein for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention is directed to wireless networks authentication infrastructures. More particularly, the invention provides methods for performing intra-domain inter-access controller authentication based on IEEE 802.11r in Control And Provisioning of Wireless Access Points (CAPWAP) architecture. Merely by way of example, the invention has been applied to the first-time 802.11r association as well as the network re-association of the mobile station adopted to CAPWAP environment and optimization on the authentication using a key hierarchy. But it would be recognized that the invention has a much broader range of applicability.

FIG. 1 shows a simplified diagram of a conventional network architecture. In this architecture, Cooperate Network, which homes a router known as an access controller (AC) and an EAP server, is connected to a (wireless) Distribution System via Internet. The Distribution System managed a plurality of network access nodes known as access points (AP). For example, the AP is a Wi-Fi Cell. Mobile Stations (MS) can attach with the network through any access point and may move from a link via one access point to a link via another access point. Control And Provisioning of Wireless Access Points (CAPWAP) is a protocol to manage the mobility of the mobile stations between Wi-Fi access points by a centralized access controller (AC). Initial network access authentication of the mobile stations is handled by IEEE 802.1X using the authenticator which is located at the AC and an EAP server. Subsequent authentications are done by IEEE 802.11i defined secure association protocol (SAP).

802.11r is an in-progress IEEE standard that sets to specify fast BSS (Basic Service Set) transitions. Conventionally, mobile station handoffs were supported by some earlier implementations of 802.11, which was mainly designed for data communication. The handoff delay is too long to support applications like voice and video. The primary application envisioned for the 802.11r standard is VOIP (“Voice over IP”, or Internet-based telephony) via mobile phones designed to work with wireless Internet networks, such as that shown in FIG. 1, instead of (or in addition to) standard cellular networks.

On the one hand, these 802.11r enabled wireless mobile stations need to be rapidly dissociated from one access point and connect to another. For example, the delay should not exceed about 50 msec to not be detected by the human ear. However, current roaming delay in 802.11 networks average in the hundreds of milliseconds. On the other hand, these handoffs should not be performed at the expense of connection security. Today's wireless networks employ Authentication, Authorization and Accounting (AAA) infrastructure for authentication. The cross-domain roaming (or inter-domain roaming) is typically handled by inter-domain authentication via the “home” AAA server or Extensible Authentication Protocol (EAP) server. Any authentication must pass through the home server of the mobile station, which increases latency.

Hence, it is highly desirable to improve techniques for fast and secure handoffs and inter-domain authentication.

### BRIEF SUMMARY OF THE INVENTION

The present invention is directed to wireless networks authentication infrastructures. More particularly, the invention provides methods for performing intra-domain inter-access controller authentication based on IEEE 802.11r in Control And Provisioning of Wireless Access Points (CAPWAP) architecture. Merely by way of example, the invention has been applied to the first-time 802.11r association as well as the network re-association of the mobile station adopted to CAPWAP environment and optimization on the authentication using a key hierarchy. But it would be recognized that the invention has a much broader range of applicability.

In one aspect, the invention provides a solution to the inter-Access Controller authentication and 802.11r based authentication in CAPWAP architecture. In another aspect, the inter-AP authentication and CAPWAP domain roaming based on optimizations on the authentication using a key hierarchy.

In an specific embodiment, the invention provides a method for performing authentication of first-time network association of a mobile station compatible with an 802.11r protocol. The method includes forming an association between a mobile station and an access point. The access point is connected to an access controller associated with a home server. The method further includes exchanging a request/response message between the mobile station and the access controller through the access point based on the association. The request/response message includes at least information associated with a mobility domain identifier of the access controller. The mobility domain identifier includes at least a first parameter and a second parameter. Additionally, the method includes generating a first key between the mobile station and the home server based on an 802.1X protocol and sending information associated with the first key to the access controller. The method further includes generating a second key by the access controller based on at least information associated with the first key and the mobility domain identifier of the access controller. The second key is stored at the access controller. Moreover, the method includes generating a third key by performing an 802.11r four-way handshake between the access controller and the mobile station based on at least the second key. Furthermore, the method includes sending the third key in a config-request message from the access controller to the access point. The config-request message includes information associated with adding the mobile station to the access point based on the third key.

In a specific embodiment, the first key is a master session key used as an input to generate all shared authentication keys in a key hierarchy defined in 802.11r protocol. In one embodiment, a top-level shared key of the key hierarchy is root key or called pairwise master key stored at the access controller which is set to be an authenticator. The second key is a second-level shared key in the key hierarchy. In one embodiment, the second key may be associated with access point that is connected to the access controller. In another embodiment, the second key may also be kept at the access controller. The third key is a lowest-level shared key for binding the second key to the access point and for encrypting transient data between the mobile station and the access point.

Alternatively in one embodiment, after generating the first key by the home server the method includes generating a top-level key by the home server based on information at least associated with the first key and one or more parameters shared with a plurality of access controllers. Each of the plurality of access controller is associated with the home server. Additionally, the method includes broadcasting information associated with the mobile station to the plurality of the access controllers. The method in one embodiment further includes sending an access-request message using a RADIUS protocol from one of the plurality of access controllers to the home server if the mobile station hands over to said one of the plurality of access controllers. The access-request message includes at least said one or more parameters and information associated with the mobile station. Moreover, the method includes sending the top-level key to said one of the plurality of access controllers in an access-accept message by the home server. In another embodiment the RADIUS protocol can be replaced by a Diameter protocol involving an AA-request message and an AA-answer message between the access controller and the home server.

In an alternative specific embodiment, the invention provides a method for performing authentication of network re-association of a mobile station in compliance with 802.11r protocol. The method includes performing handover of a mobile station to an access point connected to an access controller. The mobile station received at least a first parameter associated with the access controller stored a first key for authentication. The method further includes exchanging an authentication request/response message between the mobile station and the access controller through the access point. The authentication request/response message includes at least information associated with the first parameter and a second parameter for identifying the access point. Additionally, the method includes generating a second key by the mobile station and the access controller using at least the first key and the second parameter. The method further includes generating a third key by the mobile station and the access controller using at least the second key. Moreover, the method includes sending the third key in a config-request message from the access controller to the access point. The config-request message includes information associated with adding the mobile station to the access point based on the third key.

In a specific embodiment, the third key can be generated by concatenating at least the second key, a first ANonce value, a first SNonce value, a MAC address for the access point, and a MAC address of the mobile station. In an alternative embodiment, the method further includes storing the second key at the access controller. The method also includes performing a handover to move the mobile station to the second access point. The second access point is one of a plurality of access points connected to the access controller. The handover corresponds to a second ANonce value for the second access point and a second SNonce value for the mobile station. Additionally, the method includes generating a fourth key by the mobile station and the access controller based on at least the second key, the second ANonce value, and the second SNonce value. The method further includes sending the fourth key in a config-request message from the access controller to the second access point. The config-request message includes information associated with adding the mobile station to the second access point based on the fourth key which is different from the third key.

In yet another specific embodiment, the invention provides a method for performing an intra-domain inter-access controller authentication using 802.11r. The method includes detecting an access point associated with a second access controller for a mobile station to hand over from a first access controller. The first access controller is associated with a home server and configured to store a first key for authentication. The second access controller is also associated with the home server. The method further includes sending an authentication request from the mobile station to the second access controller through the access point. The authentication request includes at least a first parameter associated with the first access controller. Additionally, the method includes sending an access request from the second access controller to the home server. The access request comprises a plurality of parameters including at least the first parameter and a second parameter. The second parameter is associated with the second access controller. The method further includes generating a second key by the home server using the plurality of parameters and replying an access-accept message to the second access controller. The access-accept message includes at least the second key which is stored at the second access controller identified by the second parameter. Moreover, the method includes receiving an authentication response by the mobile station from the second access controller through the access point. The authentication response includes at least the second key, the second parameter, and a third parameter. The method further includes generating a third key by the second access controller based on the second key using at least the third parameter and generating a fourth key by the mobile station and the second access controller using at least the third key. Furthermore, the method includes sending the fourth key in a config-request message from the second access controller to the access point. The config-request message includes information associated with adding the mobile station to the access point based on the fourth key.

In still an alternative embodiment, the method further includes storing the third key at the second access controller. Additionally, the method includes detecting a second access point of a plurality of access points by the mobile station. Each of the plurality of access points is connected to the second access controller. The method further includes performing a handover to move the mobile station to the second access point. The handover corresponds to a second ANonce value associated with the second access point and a second SNonce value associated with the mobile station. Moreover, the method includes generating a fifth key by the mobile station and the second access controller based on at least the third key, the second ANonce value, and the second SNonce value. Furthermore, the method includes sending the fifth key in a config-request message from the second controller to the access point. The config-request message includes information associated with adding the mobile station to the access point based on the fifth key which is different from the fourth key.

Many benefits are achieved by way of the present invention over conventional techniques. For example, certain embodiments of the present invention can provide smooth handover access to mobile stations when it enters the range of another access point (or Wireless Termination Point WTP) within the same network domain. The handover is supported by Fast BSS Transition defined in IEEE 802.11r for both local and split MAC WTPs where the access controller (AC) manages the authentication and handoff for a collection of WTPs. For local MAC WTPs, AC is implemented to computes and holds authentication key for lower level elements i.e., all the neighboring WTPs, of a key hierarchy defined by IEEE 802.11r. For split MAC WTPs, in addition to authentication key generation, the AC also is implemented to transport the session key to WTP at an end of 4-way handshake in case of a first-time association or after the authentication/association request/response exchange in case of re-association. Some embodiments also provide optimization on the intra-domain inter-access controller authentication using 802.11r within CAPWAP architecture where the access controller is set as an authenticator for the network peers under an 802.11r key hierarchy. Certain embodiments simplifies the key distribution through the key hierarchy using a single pairwise master key for all access points connected to the same access controller, while a unique pairwise session key can be still obtained by using an updated random ANonce and SNonce values as inputs for particular handover re-association session. Alternatively, the access controller before handoff can act as an anchor authenticator for trigger other access controllers within the network domain to obtain a top-level authentication key from the home server.

Certain embodiments of the present invention provide a use of the encapsulation and transport mechanism included in CAPWAP protocol. For example, certain message can be tunneled between the AC and WTPs in a context transfer data format using User Datagram Protocol (UDP). Some embodiments of the present invention enable built-in security features to provide improved protection for the WTPs and AC. Other embodiments of the present invention ensure that the mobile station has an association with a single WTP, and ensure that forwarding tables of the switches are updated when the station does a handover to another WTP.

Various additional objects, features and advantages of the present invention can be more fully appreciated with reference to the detailed description and the accompanying drawings that follow.

### BRIEF DESCRIPTION OF THE DRAWINGS

FIG. 1 is a simplified diagram illustrating a conventional network architecture;

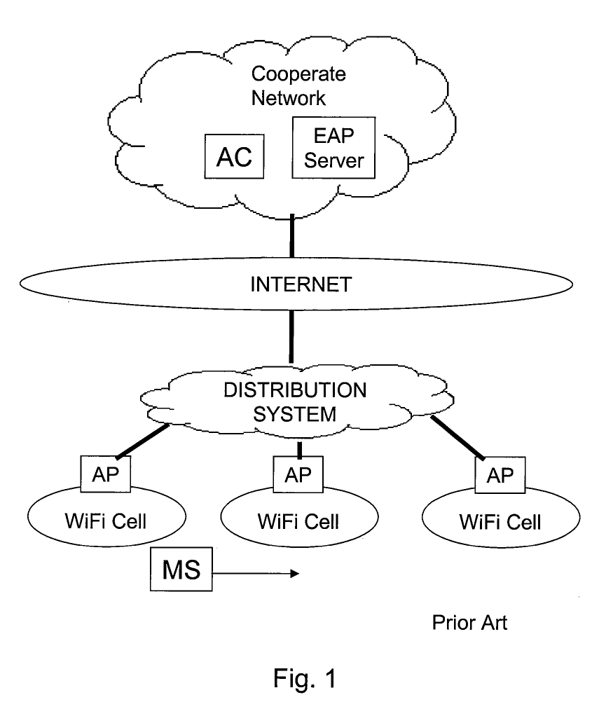

FIG. 2 is a simplified method for new network discovery with 802.11r based authentication according to an embodiment of the present invention;

FIG. 3 is a simplified diagram illustrating an authentication key hierarchy defined in IEEE 802.11r protocol;

FIG. 4 is a simplified method for authentication of a first-time network association of a mobile station using 802.11r protocol in CAPWAP architecture according to an embodiment of the present invention;

FIG. 5 is a simplified diagram illustrating procedures of first time 802.11r network association of a mobile station according to an embodiment of the present invention;

FIG. 6 is a simplified method for authentication of network re-association of a mobile station using 802.11r protocol in CAPWAP architecture according to an embodiment of the present invention;

FIG. 7 is a simplified diagram illustrating procedures of 802.11r network re-association of a mobile station according to an embodiment of the present invention;

FIG. 8 is a simplified method for performing mobile station intra-domain authentication using 802.11r in CAPWAP architecture according to an embodiment of the present invention; and

FIG. 9 is a simplified diagram illustrating procedures for mobile station intra-domain authentication using 802.11r in CAPWAP architecture according to an embodiment of the present invention.

### DETAILED DESCRIPTION OF THE INVENTION

The present invention is directed to wireless networks authentication infrastructures. More particularly, the invention provides methods for performing intra-domain inter-access controller authentication based on IEEE 802.11r in Control And Provisioning of Wireless Access Points (CAPWAP) architecture. Merely by way of example, the invention has been applied to the first-time 802.11r association as well as the network re-association of the mobile station adopted to CAPWAP environment and optimization on the authentication using a key hierarchy. But it would be recognized that the invention has a much broader range of applicability.

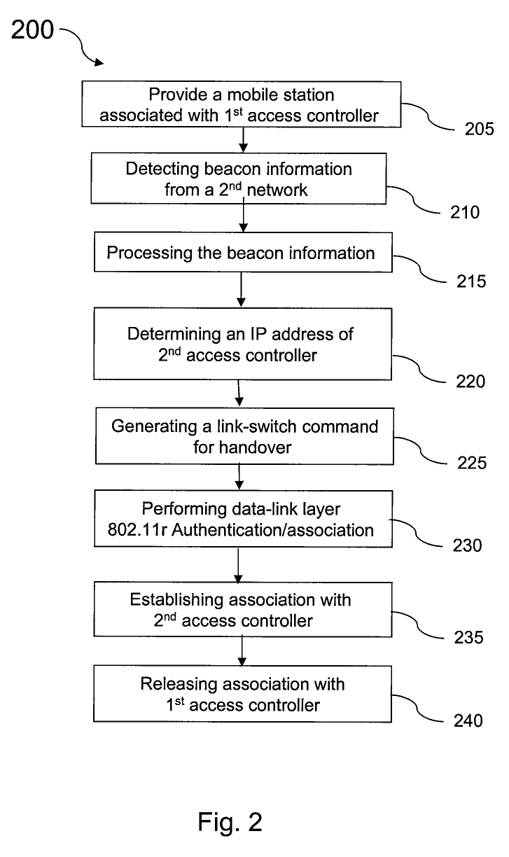

In a specific embodiment, the invention provides a method for new network discovery with 802.11r based authentication. A method 200 as illustrated by FIG. 2 according to an embodiment of the present invention can be outlined as follows:

1. Process 205: Providing a mobile station associated with a first access controller in a first network;

2. Process 210: Detecting beacon information from a second network;

3. Process 215: Processing the beacon information to derive a MAC address of a second access controller;

4. Process 220: Determining an IP address of the second access controller in the second network;

5. Process 225: Generating a link-switch command for handover;

6. Process 230: Performing data-link layer 802.11r authentication/association;

7. Process 235: Establishing association between mobile station and second access controller;

8. Process 240: Releasing association between mobile station and first access controller.

These sequences of processes provide a way of performing a method according to an embodiment of the present invention. As can be seen, the method provides a technique for new network discovery according to a specific embodiment of the invention. Of course, there can be variations, modifications, and alternatives. For example, this method of network discovery not only can be applied for mobile stations but also support stationary uses. As an example, the network discovery triggers the intra-domain inter-access point handover under one access controller or the inter-access controller handover during which the 802.11r based authentication instead of full home server authentication according to certain embodiments of the present invention can be applied.

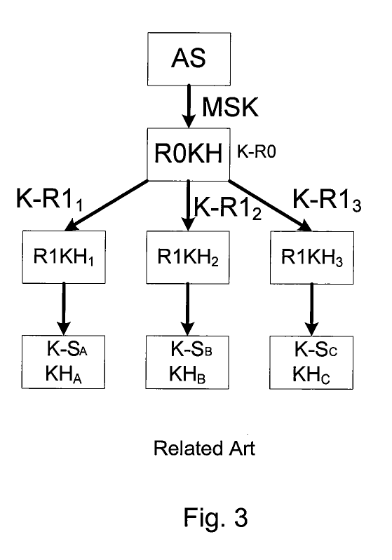

For the authentication between network elements and network domain, using authentication keys is a feasible approach. IEEE 802.11r has defined a hierarchy of authentication keys or a key management framework, as shown in FIG. 3. This diagram is merely an example, which should not unduly limit the scope of the claims herein. One of ordinary skill in the art would recognize other variations, modifications, and alternatives. As shown, the key hierarchy includes two levels of key holders arranged into security domains. The mobile stations affiliating with the key hierarchy forms a security mobility domain. From the full EAP authentication, the EAP server or simply an Authentication Server (AS) and the Mobile Station (MS) generate a Master Session Key (MSK). In one embodiment, this MSK key becomes an input to the key hierarchy. In another embodiment, the MSK determines the identification of an access node belonging to a particular network via AS. At the top-level R0 of the key hierarchy there is a root key, K-R0. K-R0 key is stored at a network element called the R0 key holder (R0KH). The term “root key” is broadly defined as a top-level key in the key hierarchy according to the present invention. For example, a root key may be used to derive other second-level keys to be used for a layered network authentication and security association.

In a preferred embodiment, K-R0 key holder is an access controller (AC) which assumes the role of the mobility domain controller which sets the mobility domain identifier in the network domain. After the domain network is discovered, AC sends all APs an IEEE 802.11 WLAN configuration-request message including the mobility domain information element (MDIE) defined in 802.11r protocol. In one embodiment, the MDIE includes a data field for Mobility Domain Identifier (MDID) which is a 48-bit value that is used for uniquely identifying this particular domain. In addition, there is another data bit of Fast BSS transition capability within a data field of Fast BSS transition capability and resource policy. AC sets value of this data bit to 1. In another embodiment, MDID is used in calculating K-R0 key based on the input of MSK. The K-R0 key is a shared secret key called Pairwise Master Key (PMK). The PMK is designed to last the entire connection session for one of access points (APs) associated with the AC and should be exposed as little as possible. Both Split MAC APs and Local MAC APs will advertise MDID in their beacons which can be detected by mobile stations (MS) in the neighbourhood. Of course, there can be variations, modifications, and alternatives.

The second-level in the key hierarchy is R1. Accordingly, second-level key K-R1 is stored at a network element named as the R1 key holders (R1KH). There are three R1KHs shown in FIG. 3, R1KH1, R1KH2, and R2 KH3. Of course, there can be any number of second-level key holders under a top-level root key holder. In one embodiment, K-R1 key can also be stored at a R0 key holder. In another embodiment, all the second-level keys can be the same within the network domain. The R1KHs use the secure association protocol (SAP) such as 802.11i 4-way handshake to derive a session key, K-S, which is the lowest-level key in the key hierarchy with the MS. For example, R1KH1 does a SAP exchange with MS in order to derive K-S_{A} which is used as the session key between R1KH1 and MS.

In an alternative embodiment, MS also needs the identifiers of R0 and R1 key holders (i.e., R0KH-ID and R1KH-ID). These information can be shared through an IEEE 802.11 WLAN configuration-request message sent by AC through the access point associated with the mobile station. The IEEE 802.11 WLAN configuration-request message defined in CAPWAP architecture includes the Fast BSS Transition Information (FTIE) defined in 802.11r protocol. In one embodiment, FTIE includes AC's identifier in both the required R0KH-ID parameter and optional R1KH-ID parameter. R0KH-ID is used in calculating K-R0 key. R1 KH-ID is used in calculating K-R1 key. In another embodiment, both Split MAC and Local MAC access points advertise FTIE containing R0KH-ID and R1 KH-ID in probe responses.

According to certain embodiments of the present invention, in CAPWAP architecture the AC is set to the authenticator and also holds K-R1 keys. For example, AC is in charge of doing the SAP exchanges with MS and deriving the session key. In one embodiment, AC then has to transport the session key to the access point (AP). The authentication procedure can be optimized using the key hierarchy within 802.11r protocol mention above. In one embodiment, the key hierarchy defined in 802.11r protocol is used for optimizing the inter-access-point authentication procedures. Further details of this improved authentication method can be found throughout the specification and particularly below.

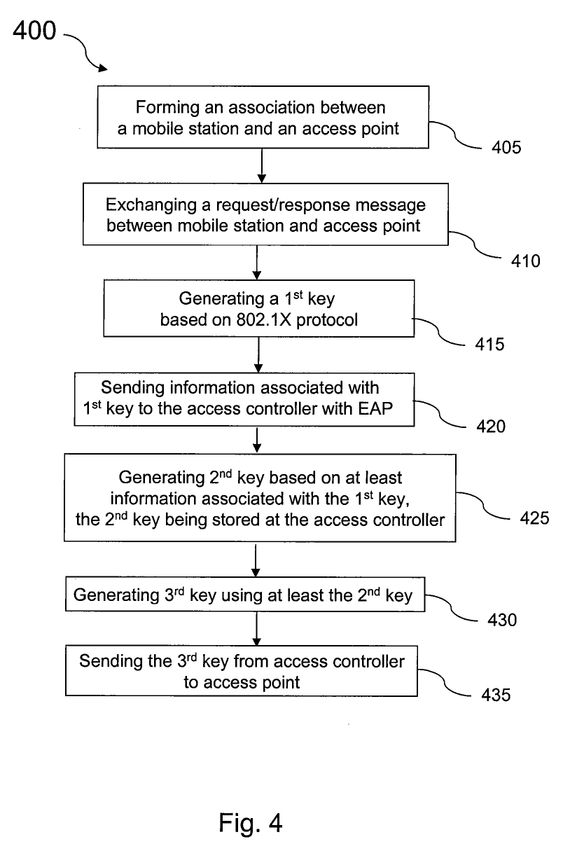

In an specific embodiment, the invention provides a method for inter-access-point authentication for MS first time association using an 802.11r protocol in CAPWAP architecture as illustrated by FIG. 4. A method 400 according to an embodiment of the present invention can be outlined as follows:

1. Process 405: Forming an association between a mobile station and an access point (associated with an access controller and a home server);

2. Process 410: Exchanging a request/response message between the mobile station and the access point;

3. Process 415: Generating a first key based on 802.1X protocol;

4. Process 420: Sending information associated with the first key to the access controller with EAP;

5. Process 425: Generating a second key based on at least information associated with the first key, the second key being stored at the access controller;

6. Process 430: Generating a third key by the mobile station and the access controller using at least the second key;

7. Process 435: Sending the third key in a configuration-request message from the access controller to the access point.

These sequences of processes provide a way of performing a method according to an embodiment of the present invention. Of course, there can be variations, modifications, and alternatives. Some processes may be removed or replaced by other processes. For example, after the first key is generated at the home server in the process 415, the home server can generate a top-level key (or a K-R0 key) based on at least the first key instead of sending the first key to the access controller. Other processes can be added into above sequences or repeated multiple times. As an example, the process 425 may be performed by the access controller to generate a second key for each of a plurality of APs within the network domain. The second key is a pairwise shared key that may be used not only for first time association between one AP and the MS, but also for the MS re-association with a new AP within the network domain. Further details of the present method can be found throughout the present specification and more particularly below.

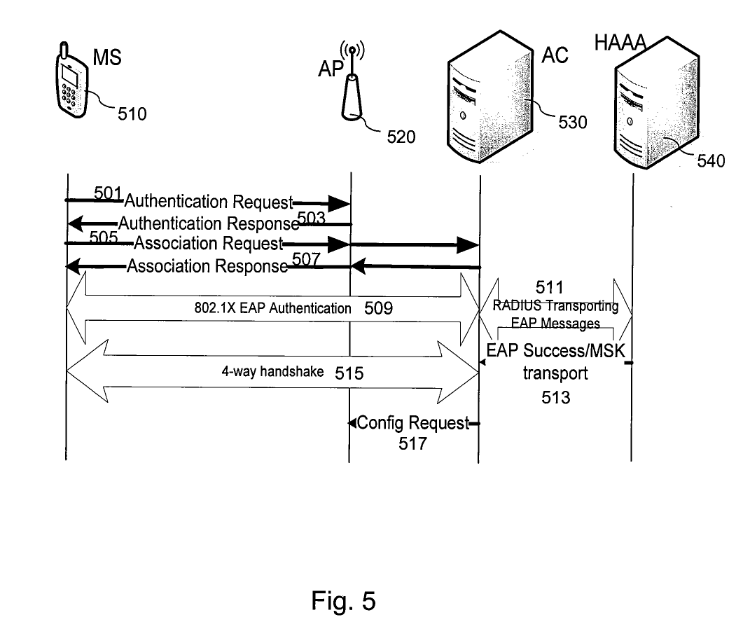

As an example of the method 400, FIG. 5 uses a simplified diagram to illustrate procedures of inter-access-point authentication for first time 802.11r association of a mobile station using an 802.11r protocol in CAPWAP architecture according to an embodiment of the present invention. This diagram is merely an example, which should not unduly limit the scope of the claims herein. One of ordinary skill in the art would recognize other variations, modifications, and alternatives. In a preferred embodiment, MS 510 forms an initial mobility domain association with an access point AP 520. The AP 520 is associated with an access controller under a home server. For example, this is provided in the process 405. The home server is configured to provide authentication, authorization, and accounting services. For example, the home server is HAAA server 540. As shown in FIG. 5, the initial mobility domain association process includes an open system authentication indicated in an authentication request message 501 and an authentication response message 503 exchanged between the MS 510 and AP 520.

In an embodiment of the present invention, the MS 510 sends an association request message 505 to the AP 520. In part of the process 510, the association request frame is sent to the AC 530 as a user datagram protocol (UDP) message with payload as the frame contents. For example, the UDP message is sent from the AP520 to the AC 530 in a tunneling mode defined in Control And Provisioning of Wireless Access Points (CAPWAP) architecture. AC 530 processes the UDP message and replies an UDP response frame that is tunneled in UDP payload back to AP 520 in another part of the process 410. AP 520 then sends an association response message 507 back to MS 510. The association response message 507 includes at least information associated with a mobility domain identifier of the access controller AC 530. For example, the mobility domain identifier can be represented by a 48-bit value that uniquely identifies this network domain. In one embodiment, the mobility domain identifier includes a first parameter for identifying an entity for storing a top-level key for authentication and a second parameter for identifying an entity for storing a second-level key. For example, the top-level key is called K-R0 key. The network element for storing the top-level key is called the root key (R0 key) holder. The first parameter of the mobility domain identifier can be correspondingly denoted R0KH-ID. The second-level key is for next level authentication under the root key. The network element for storing the second-level key is called R1 key holder. Thus, the second parameter of the mobility domain identifier can be correspondingly denoted as R1KH-ID. In one embodiment, the network element for storing the top-level key may be the same or different from the network element for storing the second-level key. In another embodiment, the access controller AC 530 is set for holding both the K-R0 key and the K-R1 key. In other words, the access controller, as a domain authenticator, is configured to store both the top-level key and the second-level key according to a specific embodiment of the present invention.

In an alternative embodiment, an 802.1X protocol is used for authenticate the association between the MS 510 with the home server through AP 520 and AC 530. An 802.1X Extensile Authentication Protocol (EAP) is used for transporting authentication messages from the MS 510 to the AC 530 which is a network access server (NAS) client. As shown in FIG. 5, 802.1X EAP authentication 509 is performed between the MS 510 and the AC 530 in part of the process 415. The 802.1X authentication is a port-based network access control mechanism for authenticating 802.11 based mobile station using a layered security method under a standard AAA protocol. In one embodiment, AC 530 uses a Remote Authentication Dial In User Service (RADIUS) protocol to encapsulate EAP messages 511 and sends the message 511 to the HAAA server 540 in another part of the process 415. In another embodiment, if authentication succeeds, HAAA server 540 generates a Master Session Key (MSK) and sends an encapsulated EAP Success message 513 back to the access controller AC 530 in part of the process 420. The EAP Success message 513 includes the generated MSK which will be shared with the MS 510 through 802.1X EAP transport protocol in another part of the process 420. In a specific embodiment, the MSK is a first key generated during the dynamic key exchange and management process for authentication. Of course, there can be variations, modifications, and alternatives.

In one embodiment, the MSK received by the AC 530 is used as an input to a key management/distribution system defined in 802.11r protocol. As an example, the key management/distribution system is the key hierarchy described in FIG. 3. Using the MSK the AC 530 may derive a top-level shared key, i.e., the root key K-R0. In one embodiment, the root key K-R0 is generated by the access controller based on at least information associated with the MSK using the mobility domain identifier value. In an alternative embodiment, the root key K-R0 can be generated by the home server based on the MSK and one or more other parameters associated with the access controller and the mobile station. The one or more parameters used for calculating the root key may contain several network communication parameters including shared service set identifier (SSID) of the domain, SSID length parameter, media access control (MAC) address of the mobile station, R0 key holder identifier, etc. Then the AC 530 becomes an anchor authenticator, which may broadcast information to a plurality of access controllers within the network domain under the home server 540. The information broadcasted by the AC 530 may include all information associated with the MS 510 and indicate the MS 510 has joined into the network with an initial mobility domain association with the AP 520. Whenever the MS attempts to perform an intra-domain handover to be associated with one of the plurality of access controllers, AC 530 will trigger the corresponding access controller to obtain the root key generated earlier by the home server. The process for obtaining the root key starts by sending an access-request message in a RADIUS protocol to the home server and ends with receiving the root key K-R0 in an access-accept message. The corresponding access controller can use the obtained root key for calculating all lower level authentication keys to complete the subsequent authentication process with the mobile station.

In one embodiment, the subsequent authentication process is performed following the process 425 to generate a second-level shared key. For example, with the key hierarchy as shown in FIG. 3 and the generated root key K-R0, AC 530 can further generate a second-level K-R1 key, using the first parameter within the mobility domain identifier stored in AC 530. In a specific embodiment, the K-R1 key is obtained in the process 425 and should be stored at a R1 key holder. In one embodiment, as the mobility domain identifier of the access controller has been set to include the second parameter to identify the second-level shared key. Thus the access controller is configured to store the second-level shared key. For example, AC 530 holds the K-R1 key at the end of the process 425. In other words, the AC 530 will acts as an authenticator for all the network elements located at the second-level key hierarchy.

Referring to FIG. 4 again, a key for next-level key hierarchy is generated between the AC 530 and the MS 510 as the second-level shared key in the process 430. In one embodiment, as shown in FIG. 5, this key is generated by performing an 802.11r four-way handshake key-message exchanging process 515. The 802.11r four-way handshake 515 includes a two round trips of EAP over LAN (EAPOL)-Key message exchange between the mobile station and the access controller according to an specific embodiment of the present invention. Firstly, a first EAPOL-Key message sent from MS 510 is received by AP 520. Secondly, the received EAPOL-Key message then is tunneled to AC 530 using UDP protocol including 802.11 frame contents as the payload. Thirdly, AC 530 replies AP 520 with a second EAPOL-Key message which is again tunneled in UDP format. Finally, AP 520 removes the UDP header and sends the 802.11 frame to MS 510. At the end of four-way handshake 515, a Pairwise Transient Key (PTK) is generated by the AC 530. In a specific embodiment, the PTK key is a lowest-level shared key in the key hierarchy generated at the end of the process 430. Of course, there can be variations, modifications, and alternatives.

In one embodiment, the PTK may be used for encrypting transient data including group transient key distribution during the authenticated association between the mobile station and the access point. Thus, the PTK needs to be sent to the access point to be associated with the mobile station. In the process 435 according to one embodiment of the present invention, AC 530 sends the PTK and associated context to AP 520 in a CAPWAP configuration-request message 517, as shown in FIGS. 4 and 5. The CAPWAP configuration-request message 517 is a context transfer data containing various message elements, including an Add Mobile element, an Mobile Session Key element, an IP address of access node, etc. In the Mobile Session Key message element of the CAPWAP configuration-request message, A-bit is set to zero and the PTK is included in a Key field. The IP address included in the message 517 may be a care-of IP address associated with the access controller. In another embodiment, the PTK is also used as a session key to prove the possession of the second-level K-R1 key for pairwise authentication and to bind the K-R1 key to the access point in a current session associated with the mobile station.

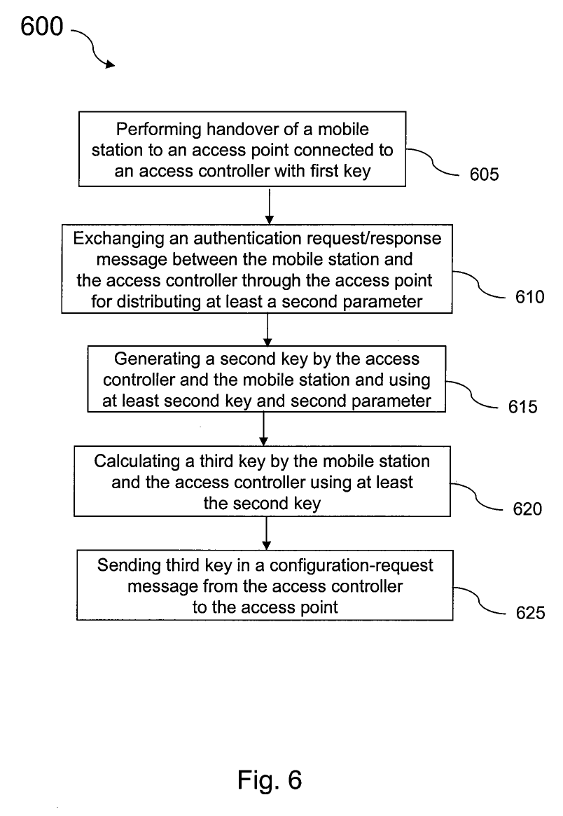

In an alternative embodiment, the invention provides a method for inter-access-point authentication for a network re-association of a mobile station using an 802.11r protocol in CAPWAP architecture according to another embodiment of the present invention as illustrated by FIG. 6. Preferably, the method 600 can be initiated when MS hands over to a new AP according to certain embodiments of the present invention. The method 600 according to an embodiment of the present invention can be outlined as follows:

1. Process 605: Performing handover of a mobile station to an access point connected to an access controller (the mobile station holding at least a first parameter for identifying the access controller with a first key);

2. Process 610: Exchanging an authentication request/response message between the mobile station and the access controller through the access point for distributing at least a second parameter;

3. Process 615: Generating a second key by the mobile station and the access controller using at least the first key and the second parameter;

4. Process 620: Calculating a third key by the mobile station and the access controller using at least the second key; and

5. Process 625: Sending the third key in a configuration-request message from the access controller to the access point.

These sequences of processes provide a way of performing a method according to an embodiment of the present invention. As can be seen, the method provides a technique for MS re-association with a new access point under 802.11r according to a specific embodiment of the invention. Of course, there can be variations, modifications, and alternatives. Further details of the present method can be found throughout the present specification and more particularly below.

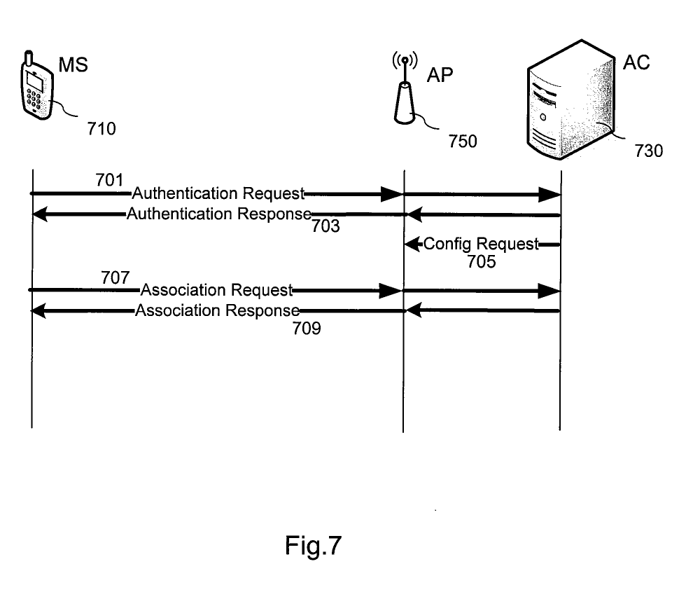

As an example of the method 600, FIG. 7 is a simplified diagram illustrating procedures of 802.11r network re-association of a mobile station according to an embodiment of the present invention. This diagram is merely an example, which should not unduly limit the scope of the claims herein. One of ordinary skill in the art would recognize other variations, modifications, and alternatives. As shown, a mobile station MS 710 performs a handover after identifying a new access point AP 720 within the same network domain. The new access point AP 720 is connected to an original access controller AC 730. For example, the MS 710 may be the same as MS 510 which was associated with an old AP 520. The AC 730 and the AC 530 are the same access controller. Therefore, the MS 710 should possess information associated with the access controller AC 730. Particularly, the information includes at least a parameter of R0KH-ID, i.e., the first parameter for identifying where the root key K-R0 is stored. According to certain embodiments of the present invention, the K-R0 key is stored at the access controller. For example, the K-R0 key is stored at the AC 730. As an example, the handover of MS 710 to connect with the AP 720 is performed in the process 605.

As shown in FIG. 7, in a specific embodiment, MS 710 sends an authentication request message 701 to the AP 720 in part of the process 610. The message 701 includes at least the first parameter, i.e., R0 key holder ID, which indicates that the AC 730 stores the root key K-R0. In another specific embodiment, the authentication request message then is tunneled to AC 730 using UDP protocol defined in CAPWAP architecture. Based on the UDP message from the AP 720, AC 730 also receives an SNonce value which is a random number generated for the MS 710 in current state. In one embodiment, the AC 730 subsequently replies to the AP 720 with another UDP message including an ANonce value generated for the AP 720. Then an authentication response message 703 is sent from the AP 720 to the MS 710 in another part of the process 610. The message 703 includes an 802.11r fast transition information element which contains a second parameter. In one embodiment, the second parameter sets a media access control (MAC) address of the AP 720 as a R1 key holder ID. In another embodiment, the second parameter may be part of the mobility domain identifier set for the access controller AC 730. In other words, AC 730 would be the R1 key holder. Of course, there can be variations, modifications, and alternatives.

According to an embodiment of the present invention, based on at least the root key K-R0 and the second parameter for identifying a R1 key holder, a second-level key, K-R1, in the key hierarchy can be generated by the R1 key holder. For example, the AC 730 is a R1 key holder so that the K-R1 key can be generated at the AC 730 in the process 615 as shown in FIG. 6. In one embodiment, MS 710 obtains the second parameter for identifying the R1 key holder after receiving the authentication response message 703. Thus MS 710 can also generate the same second-level key which becomes a shared key between the MS 710 and the AC 730. As seen in FIG. 7, a fast transitions based on 802.11r through an authentication request/response message exchange between the mobile station and the access controller can be performed to generate the shared authentication key according to certain embodiments of the present invention without needing to perform full IEEE 802.1X authentications.

Referring to FIG. 6 again, in the process 620 a next-level key can be generated by the mobile station and the access controller using at least the second-level key. In one embodiment, the next-level key is a lowest-level key in the key hierarchy, which can be generated by performing an 802.11r four-way handshake involving two-round trips of key-message exchanges between the mobile station and the access controller. In a specific embodiment, a pairwise transient key PTK is generated by concatenating at least the following attributes: the second key, an ANonce value, an SNonce value, and a MAC address of the mobile station, and a MAC address of the access point. For example, as shown in FIG. 7, the PTK is generated at the end of the authentication response message 703. Of course, there can be variations, modifications, and alternatives.

In another embodiment, the PTK can be used for encrypting transient data during the authenticated association between the mobile station and the access point. Thus, the PTK needs to be sent to the access point to be associated with the mobile station. For example, AC 830 sends the PTK and associated context to AP 720 in a CAPWAP configuration-request message 705 in the process 625. The CAPWAP configuration-request message 705 is a context transfer data containing various message elements, including an Add Mobile element, an Mobile Session Key element, etc. In one embodiment, in the Mobile Session Key message element of the CAPWAP configuration-request message, A-bit is set to zero and the PTK is included in a Key field. In another embodiment, the PTK is also used to prove the possession of the second-level key for shared authentication and to bind the second-level key to the access point in the new session of re-association. In other words, the AP 720 and MS 710 establish an authenticated re-association using the PTK as a session key. In a specific embodiment, the PTK can be used for protections of the re-association request/response transactions. As shown in FIG. 7, MS 710 exchanges the association request message 707 and association response message 709 with the AP 720 through which the mobile network re-association is established. Of course, there can be variations, modifications, and alternatives.

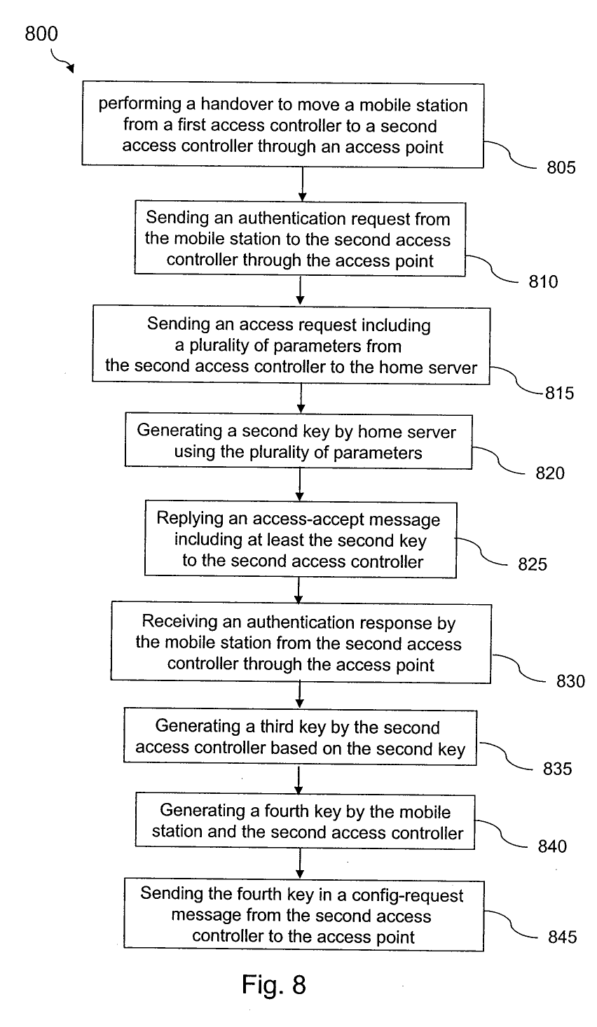

During handover, if the current AC changes, one scenario is the new AC is still in the same domain as the current AC associated with a same home server. This is called intra-domain handover. In this case, the current AC can acts as an anchor authenticator for providing a top-level root key for authentication. While the new AC may obtain a new root key using a key distribution mechanism based on the original root key. In a specific embodiment, the invention provides a method for performing intra-domain inter-access controller authentication using 802.11r protocol in CAPWAP architecture as illustrated by FIG. 8. A method 800 according to an embodiment of the present invention can be outlined as follows:

1. Process 805: Performing a handover to move a mobile station from a first access controller to a second access controller through an access point;

2. Process 810: Sending an authentication request from the mobile station to the second access controller through the access point;

3. Process 815: Sending an access request including a plurality of parameters from the second access controller to the home server;

4. Process 820: Generating a second key by the home server using the plurality of parameters;

5. Process 825: Replying an access-accept message including at least the second key to the second access controller;

6. Process 830: Receiving an authentication response by the mobile station from the second access controller through the access point;

7. Process 835: Generating a third key by the second access controller based on the second key;

8. Process 840: Generating a fourth key by the mobile station and the second access controller;

9. Process 845: Sending the fourth key in a config-request message from the second access controller to the access point.

These sequences of processes provide a way of performing a method according to an embodiment of the present invention. As can be seen, the method provides a technique for inter-domain handover initiated by the network discovery and selection procedure according to a specific embodiment of the invention. Of course, there can be variations, modifications, and alternatives. For example, because the authenticator is located at the access controller, the method 800 can be applied for both the Split MAC access points and Local MAC access points. Further details of the present method can be found throughout the present specification and more particularly below.

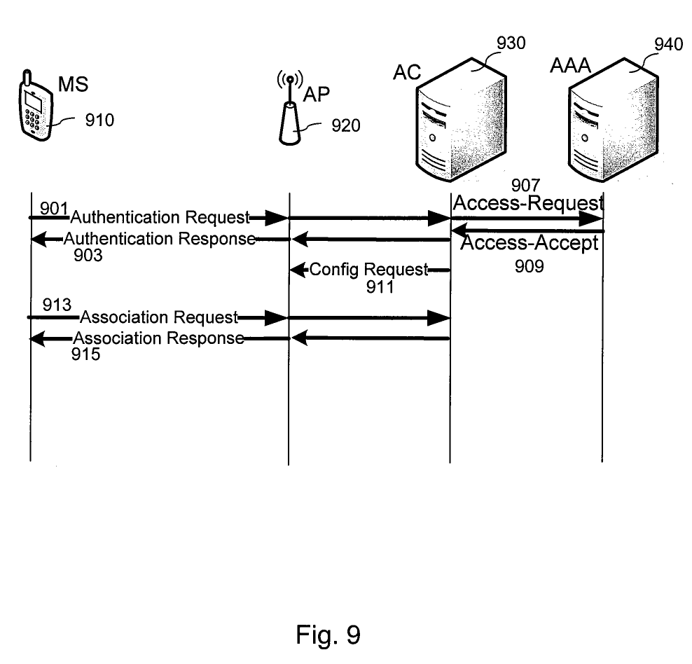

As an example, the method 800 can be specifically illustrated in FIG. 9. The FIG. 9 is a simplified diagram illustrating procedures for performing intra-domain inter-access controller authentication of a mobile station using an 802.11r protocol in CAPWAP environment according to an embodiment of the present invention. This diagram is merely an example, which should not unduly limit the scope of the claims herein. One of ordinary skill in the art would recognize other variations, modifications, and alternatives.

In a specific embodiment, the intra-domain inter-access controller authentication starts with a handover of a mobile station from a first access controller to a second access controller. The handover is initiated by detecting an access point for the mobile station to attach in the process 805 of the method 800. As shown in FIG. 9, a mobile station MS 910, which was associated with an old access controller (old AC) under a home server 940, detects a new access point AP 920 for attachment. The AP 920 is connected to a new access controller AC 930 which is also associated with the same home server 940. In one embodiment, the MS 910 performs an intra-domain handover to de-associate with the old AC and associate with the new AC 930 through the new AP 920. According to an embodiment of the present invention and as described in this specification, the old AC is configured to store a top-level root key K-R0 used for authenticating the association between the MS 910 and the old AC. The old AC's mobility domain identifier includes at least a first parameter R0KH-ID for identifying that the K-R0 key is stored at the old AC. In one embodiment, this first parameter is distributed to the MS 910 during the authentication/association between the MS 910 and the old AC. For example, the MS 910 obtains the first parameter through detecting a beacon with the AC's mobility domain identifier advertised by an old access point that is connected to the old AC. In another embodiment, the old AC holds all information associated with the MS 910 which will be used for facilitate the handover authentication. In an alternative embodiment, the old AC acts as an anchor authenticator while any new AC will be a direct authenticator after the intra-domain handover. Of course, there can be variations, modifications, and alternatives.

In one embodiment, as the MS 910 hands over to the new AP 920, it can send an authentication request message 901 to the AP 920 as shown in FIG. 9. The authentication request message 901 includes at least the first parameter R0KH-ID and a random value, SNonce, generated for the MS 910 in a current state after the handover. For example, this is performed in part of the process 810. Further, the authentication request message is encapsulated using a UDP protocol by the AP 920 and tunneled to the new AC 930 with all the information associated with the MS 910, the first parameter, and the SNonce value. For example, this is performed in another part of the process 810. In a specific embodiment, this UDP encapsulated message is tunneled to the AC 930 by the AP 920 as defined in CAPWAP protocol binding for IEEE 802.11r. The UDP encapsulated message includes a 4/16 octets IP address of the AC 930. Of course, there can be variations, modifications, and alternatives.

In a specific embodiment, after receiving the UDP encapsulated message from AP 920, AC 930 determines that the first parameter R0KH-ID may be different from what is set in its own mobility domain identifier. AC 930 needs to get its own top-level root key for the current association session after the handover. In one embodiment, AC 930 sends an access-request message 907 to the home server AAA 940 as shown in FIG. 9. As an example, this is performed using process 815 of method 800. The access-request message 907 includes a plurality of parameters related to MS 910 and AC 930. For example, the plurality of parameters includes at least the first parameter R0KH-ID, a service set identifier (SSID) parameter associated with the network domain, SSID length parameter, 48-bit mobility domain identifier (MDID) parameter associated with AC 930, a media access control (MAC) address of MS 910, etc. In another embodiment, the access-request message is sent using a standard AAA protocol. For example, the RADIUS protocol is used for encapsulate message 907. Of course, there can be variations, modifications, and alternatives.

In another specific embodiment, the home server can generate a new root key using at least the plurality of parameters. For example, a new K-R0 key is generated by home server AAA 940 using the plurality of parameters related to MS 910 and AC 930 in the process 820 of method 800. The new root key can be used as a top-level key for pairwise authentication and needs to be sent to corresponding authenticator which is in fact the new access controller after the handover. For example, the generated K-R0 key is sent by AAA 940 to AC 930 in an access-accept message 909, as shown in FIG. 9. As an example, this is performed using process 825 of the method 800. In one embodiment, the AC 930 is configured to store the received new K-R0 key. The access-accept message 909 is also an RADIUS protocol encapsulated message including at least a second parameter for identifying that the new K-R0 key is stored at the AC 930. In another embodiment, the second parameter may be set into the mobility domain identifier of the AC 930. Of course, there can be variations, modifications, and alternatives.

In one embodiment, the AC 930 can send information associated with the K-R0 key in another UDP message in tunnel mode to the AP 920. The UDP message back to AP 920 may include another random value, ANonce, generated for the AP 920, as well as a third parameter. The AP 920 further can return these information back to the MS 910 in an authentication response message 903, as shown in FIG. 9. As an example, this is performed using process 830 of the method 800. In one embodiment, the third parameter is designed for identifying where a second-level shared authentication key is stored. For example, the third parameter may be associated with a MAC address of the AP 920. Of course, there can be variations, modifications, and alternatives.

According to certain embodiments of present invention, the AC 930 acting as an authenticator for MS 910 after the handover can generate a second-level shared key for subsequent authentication process based on a key hierarchy defined in an 802.11r protocol. For example, AC 930 uses the K-R0 key and the third parameter to generate a K-R1 key for the AP 920 in the process 835 of the method 800. In one embodiment, since the K-R1 key and the third parameter have been distributed to MS 910 in the authentication response message 903, MS 910 is capable of generating a same K-R1 key using the known K-R0 key and the third parameter. In another embodiment, the MAC address of the AP 920 may be set as the third parameter which has been designed for identifying where a second-level key is stored. Thus the generated K-R1 key can be stored at the AP 920 and becomes a second-level shared authentication key between MS 910 and AP 920. In yet another embodiment, the third parameter is set within the mobility domain identifier of AC 930 so that the K-R1 key is also kept in AC 930. In this scenario, no need for R1 key distribution. Of course, there can be variations, modifications, and alternatives.

In another embodiment, a next-level transient key can be further generated between the mobile station and the new access controller at the end of the authentication response. The next-level transient key is a lowest-level pairwise transient key (PTK) within the key hierarchy for uniquely binding the K-R1 key to the access point. For example, the PTK can be generated between MS 910 and AC 930 using at least the K-R1 key in the process 840 of the method 800. In a specific embodiment, the process 840 comprises performing an 802.11r four-way handshake operation between MS 910 and AC 930, wherein some UDP encapsulated messages using format defined in CAPWAP architecture will be exchanged between the AC 930 and AP 920. In another embodiment, the PTK may be generated by concatenating at least the following attributes: the third key, an ANonce value, an SNonce value, a MAC address of the mobile station, and a MAC address of the access point. Of course, there can be variations, modifications, and alternatives. In certain embodiments, the PTK may be generated using 802.11i four-way handshake between MS 910 and AP 920 if the K-R1 key is held by the AP 920 and the access point is designed as an authenticator.

In another specific embodiment, since AC is the authenticator, the generated fourth key will be sent to the access point that is associated with the mobile station after the intra-domain handover. For example, this is performed in the process 845 of the method 800. As shown in FIG. 9, AC 930 sends the PTK, i.e., the lowest-level transient key, to the AP 920 in a CAPWAP configuration-request message. In one embodiment, the CAPWAP configuration-request message includes the PTK in an IEEE 802.11r fast transient information element (FTIE) defined in CAPWAP architecture. For example, the FTIE contains several CAPWAP data packets including an Add-Mobile message element and an Mobile-Session-Key message element. In the Mobile-Session-Key message element, A-bit is set to zero and the PTK is included in the corresponding key-field of the message element. In a specific embodiment, the PTK is used as a session key for encrypting transient data in the current association session after the mobile station hands over to the new access point AP 920. As shown in FIG. 9, MS 910 exchanges an association request message 913 and an association response message 915 with the AP 920 through which the authenticated association is established. Of course, there can be variations, modifications, and alternatives. Of course, there can be variations, modifications, and alternatives.

In an alternative specific embodiment, a new access controller is configured to store the generated a second-level shared key, i.e., K-R1 key. Since the access controller is designed as the authenticator at the top-level of key hierarchy defined in FIG. 3, this K-R1 key may be used for a plurality of access points that connected to this access controller. If the mobile station moves to a new access point of the plurality of access points, a unique PTK needs to be generated to bind the K-R1 key between the mobile station and the corresponding access point as a session key for encrypting the transient data to protect the network association. The PTK can be generated using the K-R1 key stored at the access controller to perform an 802.11r four-way handshake process between the mobile station and access controller. At the end of the four-way handshake, the PTK can be obtained by concatenating several parameters including the K-R1 key, an ANonce value newly generated for the access point and an SNonce value newly generated for the mobile station in current session after the handover. Because for each session the random numbers ANonce and SNonce have unique values, the corresponding session key PTK would be unique for each handover under the same access controller.

It is also understood that the examples and embodiments described herein are for illustrative purposes only and that various modifications or changes in light thereof will be suggested to persons skilled in the art and are to be included within the spirit and purview of this specification and scope of the appended claims.

What is claimed is:

1. A method for performing authentication of a first-time network association for a mobile station compatible with an 802.11r protocol, the method comprising:
forming an association between a mobile station and an access point, the access point being connected to an access controller associated with a home server;
exchanging a first message between the mobile station and the access controller through the access point based on the association, the first message including at least information associated with a mobility domain identifier of the access controller, the mobility domain identifier including at least a first parameter and a second parameter;
generating a first key between the mobile station and the home server based on an 802.1X protocol;
sending information associated with the first key from the home server to the access controller;
generating a second key by the access controller based on at least information associated with the first key and the mobility domain identifier of the access controller, the second key being stored at the access controller;
generating a third key by performing an 802.11r four-way handshake between the mobile station and the access controller based on at least the second key; and
sending the third key in a second message from the access controller to the access point, the second message including information associated with adding the mobile station to the access point based on the third key;
wherein,
the first key is a master session key used as an input to derive a top-level shared key in a key hierarchy defined in 802.11r protocol;
the second key is a second-level shared key in the key hierarchy;
the third key is a lowest-level shared key for binding the second key to the access point and for encrypting transient data between the mobile station and the access point.

2. The method of claim 1 wherein the access point is either a split media access control (MAC) wireless termination point (WTP) or a local MAC WTP.

3. The method of claim 1 wherein the exchanging a first message between the mobile station and the access controller through the access point based on the association comprises:
sending a request message from the mobile station to the access point;
tunneling the request message from the access point to the access controller in a user datagram protocol (UDP) encrypted message;
replying a response message in UDP tunnel mode to the access point, the response message including at least information associated with a mobility domain identifier of the access controller;
receiving the response message by the mobile station from the access point.

4. The method of claim 1 wherein the generating a second key by the access controller comprises:
deriving a top-level key based on at least the information associated with the first key and the mobility domain identifier of the access controller, the access controller being configured to store the top-level key;
generating the second key based on at least the top-level key and the second parameter of the mobility domain identifier.

5. The method of claim 1 wherein:
the first parameter of the mobility domain identifier is for identifying that the top-level key is stored at the access controller; and
the second parameter of the mobility domain identifier is for identifying where the second key is stored.

6. The method of claim 5 wherein the second key is stored at the access controller.

7. The method of claim 5 wherein the second parameter comprises a media access control (MAC) address of the access point.

8. The method of claim 1 wherein the generating a third key by performing an 802.11r four-way handshake between the mobile station and the access controller comprises:
sending a key-exchange message to the access point, the key-exchange message including an SNonce value and a MAC address of the mobile station;
encapsulating the key-exchange message with a user datagram protocol (UDP);
tunneling the encapsulated key message to the access controller;
replying the key-exchange message in UDP tunnel mode to the access point, the key message including the second key;
receiving the second key by the mobile station from the access point in an 802.11 data frame including an ANonce value and a MAC address of the access point without UDP header; and
generating the third key by concatenating at least the second key, the SNonce value, the MAC address of the mobile station, the ANonce value, and the MAC address of the first access point.

9. The method of claim 1 wherein the sending the third key in a second message to the access point comprises sending a configuration-request message using a CAPWAP protocol binding for IEEE 802.11.

10. The method of claim 1 after the generating a first key, further comprising:
generating a top-level key by the home server based on information at least associated with the first key and one or more parameters shared with a plurality of access controllers, each of the plurality of access controller being associated with the home server;
broadcasting information associated with the mobile station to the plurality of the access controllers;
sending an access-request message using a RADIUS protocol from one of the plurality of access controllers to the home server if the mobile station hands over to said one of the plurality of access controllers, the access-request message including at least said one or more parameters and information associated with the mobile station;
sending the top-level key to said one of the plurality of access controllers in an access-accept message by the home server.

11. A method for performing authentication of network re-association of a mobile station in compliance with an 802.11r protocol, the method comprising:
performing handover for a mobile station connecting to an access point that is connected to an access controller, the mobile station receiving at least a first parameter associated with the access controller stored a first key for authentication;
exchanging an first message between the mobile station and the access controller through the access point, the first message including at least information associated with the first parameter and a second parameter for identifying the access point;
generating a second key by the mobile station and the access controller using at least the first key and the second parameter;
generating a third key by the mobile station and the access controller using at least the second key;
sending the third key in a second message from the access controller to the access point, the second message including information associated with adding the mobile station to the access point based on the third key;
wherein,
the first key is a top-level shared key of a key hierarchy defined in 802.11r protocol;
the second key is a second-level shared key in the key hierarchy;
the third key is a lowest-level shared key for binding the second key to the access point and for encrypting transient data between the mobile station and the access point.

12. The method of claim 11 wherein the access point is either a split media access control (MAC) wireless termination point (WTP) or a local MAC WTP.

13. The method of claim 11 wherein the exchanging an authentication request/response message between the mobile station and the access controller through the access point comprises:
sending an authentication request from the mobile station to the access point, the authentication request including at least the first parameter for identifying the access controller with the first key;
sending the authentication request from the access point to the access controller in a user datagram protocol (UDP) encrypted message including an SNonce value generated for the mobile station;
replying the access point with a UDP message in tunnel mode, the UDP message including at least an ANonce value generated for the access point;
receiving an authentication response by the mobile station from the access point, the authentication response including the ANonce value and a second parameter for identifying the access point.

14. The method of claim 11 wherein the generating the third key between the mobile station and the access controller using at least the second key comprises concatenating at least the second key, a first ANonce value, a first SNonce value, a MAC address for the access point, and a MAC address of the mobile station.

15. The method of claim 14, and further comprising:
storing the second key at the access controller,
performing a handover to connect the mobile station to the second access point, the second access point being one of a plurality of access points connected to the access controller, the handover corresponding to a second ANonce value for the second access point and a second SNonce value for the mobile station;
generating a fourth key by the mobile station and the access controller based on at least the second key, the second ANonce value, and the second SNonce value;
sending the fourth key in a config-request message from the access controller to the second access point, the config-request message including information associated with adding the mobile station to the second access point based on the fourth key;
wherein,
the fourth key is different from the third key.

16. A method for performing an intra-domain inter-access controller authentication using 802.11r, the method comprising:
performing a handover for moving a mobile station from a first access controller to a second access controller through an access point, the first access controller being associated with a home server and stored a first key for authentication, the second access controller being associated with the home server;
sending an authentication request from the mobile station to the second access controller through the access point, the authentication request including at least a first parameter associated with the first access controller;
sending an access request from the second access controller to the home server, the access request comprising a plurality of parameters including at least the first parameter and a second parameter, the second parameter being associated with the second access controller;
generating a second key by the home server using the plurality of parameters;
replying an access-accept message to the second access controller, the access-accept message including at least the second key, the second key being stored at the second access controller identified by the second parameter;
receiving an authentication response by the mobile station from the second access controller through the access point, the authentication response including at least the second key, the second parameter, and a third parameter;
generating a third key by the second access controller based on the second key using at least the third parameter, the third key being identified by the third parameter;
generating a fourth key by the mobile station and the second access controller using at least the third key;
sending the fourth key in a config-request message from the second access controller to the access point, the config-request message including information associated with adding the mobile station to the access point based on the fourth key;
wherein:
the first key is a top-level shared key for authenticated association between the mobile station and the first access controller in a session prior to a handover;
the second key is a top-level shared key for authenticated association between the mobile station and the second access controller in a current session after the handover;
the third key is a second-level shared key for binding the current session between the mobile station and the access point;
the fourth key is a lowest-level shared key for uniquely binding the third key to the access point and encrypting transient data in the session between the mobile station and the access point.

17. The method of claim 16 wherein the plurality of parameters comprises the first parameter identifying the first key being stored at the first access controller, a service set identifier (SSID) parameter for the network domain, SSID length parameter, a mobility domain identifier (MDID) at the second access controller, and a media access control address of the mobile station.

18. The method of claim 16 wherein the access point is either a local MAC wireless termination point or a split MAC wireless termination point supporting CAPWAP architecture binding for an IEEE 802.11 fast BSS transition protocol.

19. The method of claim 16 wherein
the authentication request comprises an SNonce value generated for the mobile station;
the authentication response comprises an ANonce value generated for the access point.

20. The method of claim 16 wherein the generating a fourth key comprises concatenating at least the third key, a first ANonce value, a first SNonce value, a MAC address for the access point, and a MAC address for the mobile station.

21. The method of claim 20, and further comprising:
storing the third key at the second access controller;
detecting a second access point of a plurality of access points by the mobile station, each of the plurality of access points being connected to the second access controller;
performing a handover to move the mobile station to the second access point, the handover corresponding to a second ANonce value associated with the second access point and a second SNonce value associated with the mobile station;
generating a fifth key by the mobile station and the second access controller based on at least the third key, the second ANonce value, and the second SNonce value;
sending the fifth key in a config-request message from the second controller to the access point, the config-request message including information associated with adding the mobile station to the access point based on the fifth key;
wherein:
the fifth key is different from the fourth key.
